(19) United States
(12) Patent Application Publication
(10) Pub. No.: US 2020/0383171 A1
(43) Pub. Date: Dec. 3, 2020

(54) RELAY NODE, SIGNAL RELAY METHOD, AND COMMUNICATION SYSTEM

(71) Applicant: RENESAS ELECTRONICS CORPORATION, Tokyo (JP)

(72) Inventors: Toshiki KIYOHARA, Tokyo (JP); Hiroki SUGIMOTO, Tokyo (JP); Koji KUBOTA, Tokyo (JP)

(21) Appl. No.: 16/852,083

(22) Filed: Apr. 17, 2020

(30) Foreign Application Priority Data
May 29, 2019 (JP) 2019-100325

(51) Int. Cl. H04W 88/04; H04W 84/18; H04W 40/22; H04L 1/00

(52) U.S. Cl. CPC H04W 88/04; H04L 1/0018; H04W 40/22; H04W 84/18

(57) ABSTRACT

Controlling the transmission timing based on the random value or the serial number has a problem that the latency cannot be reduced. The latency required for signal communication from a source node to a destination node is reduced by reducing the waiting time until a relay operation is performed in each relay node including a transmission and reception unit for receiving a signal, a received signal evaluation unit for measuring the strength of a received signal when the signal is received, and a signal relay control unit for determining the delay time until the signal is transferred in accordance with the received signal strength.

### CROSS-REFERENCE TO RELATED APPLICATIONS

The disclosure of Japanese Patent Application No. 2019-100325 filed on May 29, 2019 including the specification, drawings and abstract is incorporated herein by reference in its entirety.

### BACKGROUND

The present invention relates to a communication system between wireless communication devices, and more particularly, to a relay node and a communication system arranged in a mesh network.

A technique of delivering a signal by wireless multi-hop delivery to all nodes reachable from a source node is called flooding. In a mesh network using a flooding technique, a communication system in which a plurality of relay nodes relays a signal transmitted from a transmission source node and deliver the signal to a destination node, that is, a so-called bucket relay system is adopted.

In Patent Document 1 disclosed as Japanese Unexamined Patent Application Publication No. 2000-13376, the presence notification packets are controlled so as not to be transmitted at the same timings in a plurality of radio terminals. Thus, a technique is disclosed in which interference of radio waves transmitted by a plurality of wireless terminals is avoided and receipt of presence notification packets are performed without delay. More specifically, a random value or a value calculated based on the serial number of each wireless terminal is used to control the transmission timings so as not to coincide with each other.

### SUMMARY

Controlling the transmission timing based on a random value or a serial number can avoid interference of radio waves and reduce the collision probability of a signal. However, if the transmission timing is delayed more than necessary, the radio terminal that relays the signal waits for an extra time from the reception of the signal to the transmission of the signal. As a result, the time required for signal transmission from the source node to the destination node becomes long. That is, there is a problem that the latency increases. An object of the present application is to solve this problem.

The other objects and novel features will become apparent from the description of this specification and the accompanying drawings.

The delay time until the relay node relays the signal is determined in accordance with the received signal strength when the relay node receives the signal.

According to an embodiment, latency can be reduced.

### BRIEF DESCRIPTION OF THE DRAWINGS

FIG. 1 is a block diagram showing an exemplary configuration of a relay node according to first embodiment.

FIG. 2 shows an exemplary table of received signal strengths and delay times for the first embodiment.

FIG. 3 is a diagram showing the relationship between the inter-node distance and the received signal strength.

FIG. 4 is a diagram illustrating a configuration example of a communication system of a mesh network.

FIG. 5 is a flow chart showing an exemplary relay operation in the relay nodes according to the first embodiment.

FIG. 6 is a diagram showing the relationship between the received signal strength and the delay time, i.e. latency.

FIG. 7 is a diagram showing the relation between the received signal strength and the delay time (latency) according to the first embodiment.

FIG. 8 is a block diagram showing an exemplary configuration of relay nodes according to second embodiment.

FIG. 9 is a diagram showing the relationship between the received signal strength and the delay time (latency) according to the second embodiment.

FIG. 10 is a diagram showing an exemplary table of received signal strengths and delay times according to the second embodiment.

FIG. 11 is a block diagram showing an exemplary configuration of relay nodes according to third embodiment.

FIG. 12 is a flow chart showing an exemplary relay operation in the relay nodes according to the third embodiment.

FIG. 13 is a diagram showing an exemplary configuration of a communication system of a mesh network according to the third embodiment.

### DETAILED DESCRIPTION

For clarity of explanation, the following description and drawings are appropriately omitted and simplified. In the drawings, the same elements are denoted by the same reference numerals, and a repetitive description thereof is omitted as necessary.

### First Embodiment

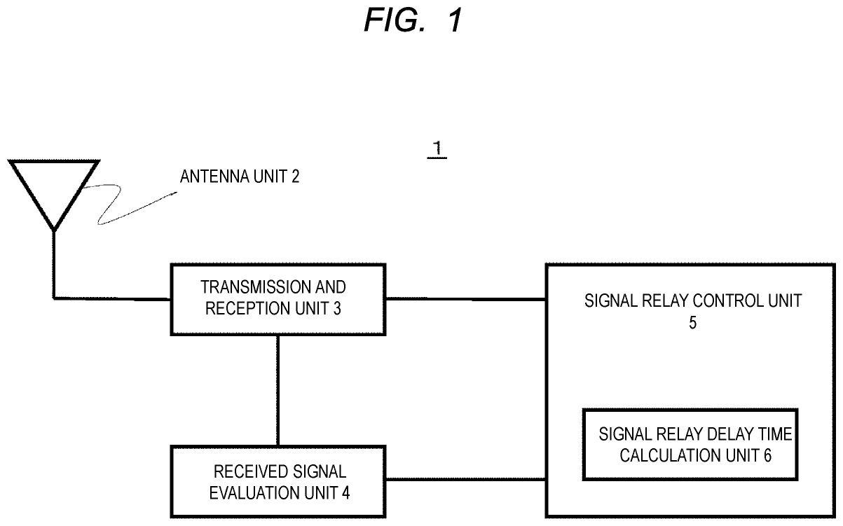

Next, details of an embodiment will be described. FIG. 1 is a block diagram showing an exemplary configuration of a relay node 1 according to the first embodiment. As shown in FIG. 1, the relay node 1 includes an antenna unit 2, a transmission and reception unit 3, a received signal evaluation unit 4, and a signal relay control unit 5.

The antenna unit 2 performs signal transmission and reception processing with other nodes existing in the radio wave reaching range of the relay node. The antenna unit 2 is electrically connected to the transmission and reception unit 3.

The transmission and reception unit 3 receives a received signal received by the antenna unit 2, and extracts an information portion from the signal. In addition, the transmission and reception unit 3 extracts an address portion from the received signal received from another node, and performs editing processing of an information portion and an address portion of a transmission signal when the signal is transferred to another node.

Received signal evaluation unit 4, when notified from the transmission and reception unit 3 that it has received the signal by measuring the received signal strength, e.g., RSSI: Received Signal Strength Indicator, notifies the signal relay control unit 5. The received signal evaluation unit 4 is electrically connected to the transmission and reception unit 3.

Here, instead of the received signal strength (RSSI), the degree of correlation with the signal of a particular pattern may be used. More specifically, the distance to a preceding node, which is a transmission source of the received signal, may be estimated from the result of correlation calculation (which may be one or a combination of self and cross correlation) between the received signal and a signal pattern, e.g., a preamble, prepared in advance. Alternatively, the received signal strength and the degree of correlation may be used in combination to estimate the distance to the preceding node. For convenience, the embodiment will be described using the received signal strength.

The signal relay control unit 5 is a block for controlling the length of the delay time until transmission to the relay node within the radio wave reaching range in accordance with the received signal strength notified from the received signal evaluation unit 4. The signal relay control unit 5 is electrically connected to the transmission and reception unit 3 and the received signal evaluation unit 4.

The signal relay control unit 5 includes a signal relay delay time calculation unit 6. The signal relay delay time control unit 6 is a block that determines a predetermined time as a delay time.

The signal relay control unit 5 notified of the received signal strength obtains a delay time based on the received signal strength. The method of deriving the delay time will be described later.

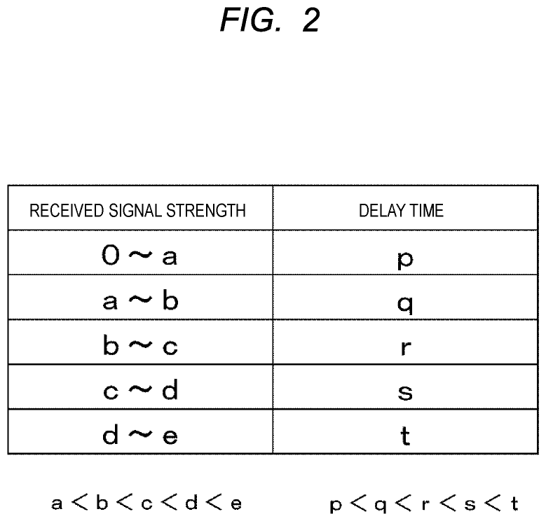

A mechanism for determining the delay time from the received signal strength will be described with reference to FIG. 2. FIG. 2 is a table defining the delay time according to the received signal strength. Each relay node holds the table shown in FIG. 2, and each time a signal is received from another node, the relay node refers to this table to obtain the delay time until the relay operation is performed. Here, the tables held by the relay nodes may be the same table or different tables may be held for each relay node. In addition, a plurality of relay nodes may hold the same table.

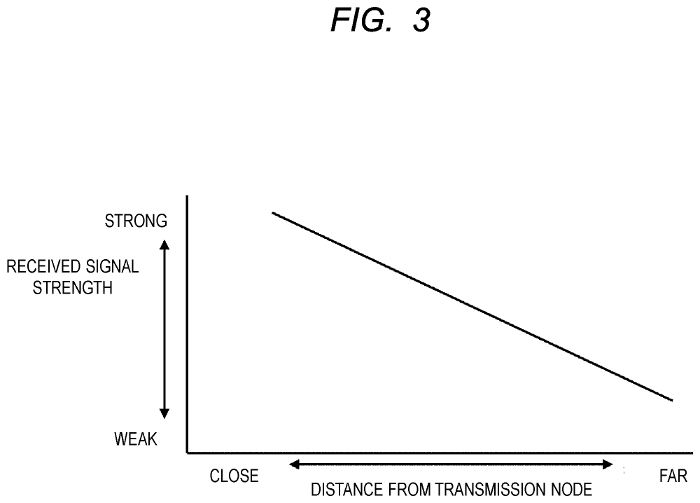

The relationship between the distance from the preceding node and the received signal strength is as shown in FIG. 3. That is, the received signal strength at the relay node receiving the signal becomes smaller as the distance from the preceding node, i.e., the node transmitting the signal received by the relay node, becomes larger.

The table shown in FIG. 2 defines a delay time corresponding to the received signal strength. The relationship between the magnitude of the received signal strength and the length of the delay time may be arbitrarily set, but it is desirable that the smaller the received signal strength, the shorter the delay time.

For example, in FIG. 2, it is assumed that the received signal strength has a relation of a<b<c<d<e, and the delay time has a relation of p<q<r<s<t. As a result, the relay node which is distant from the preceding node can preferentially perform the relay operation, and the number of relay nodes which perform the relay operation can be reduced before the signal is transmitted from the source node to the destination node. Preferably, it is suitable for communication within a wide network.

In FIG. 2, the received signal strength is divided into five sections from 0 to a predetermined value (“e” in FIG. 2), but the received signal strength may be not “d to e” but “d to infinity” so as to include a value larger than “e”. Although the received signal strength is divided into five in FIG. 2, the received signal strength is not limited to five and may be divided into arbitrary sections.

Further, the width of the received signal strength in each section may be uniform, or the width of the received signal strength in each section may have a difference based on the distribution of the received signal strength in each relay node. For example, in each node in the network, the width of each section may be determined based on the value of the data obtained by collecting the value of the received signal strength measured at the time of signal reception so that the number of data becomes equal. In addition, an incline such as subdividing a section in which the value of the received signal strength is concentrated may be provided.

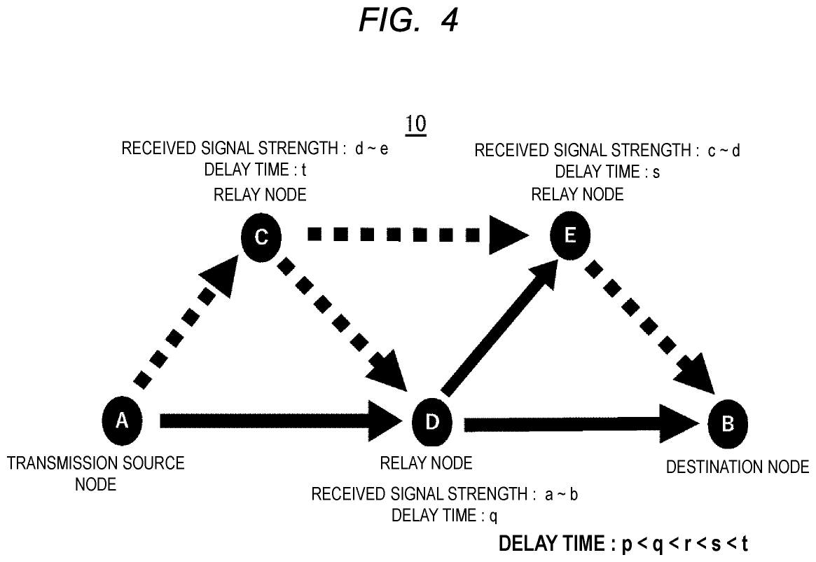

Next, a procedure for transmitting a signal from a source node to a destination node will be described using a communication system of a brief mesh network shown in FIG. 4. In the communication system 10 of FIG. 4, the node A is the source node and the node B is the destination node. Nodes C to E indicate relay nodes that transmit signals from source node A to destination node B and then transfer the signals on their paths.

The received signal strength at the relay node C receiving the signal transmitted by the source node A is within the range of “d to e”, and then “t” is set as the delay time by referring to the table shown in FIG. 2. Similarly, the received signal strength at the relay node D receiving the signal transmitted by the source node A is within the range of “a to b”, and then “q” is set as the delay time by referring to the table shown in FIG. 2.

Next, the operations of the relay node C and the relay node D that have received the signal from the transmission source node A will be described. Based on the received signal strengths at the relay nodes C and D and the table shown in FIG. 2, “t” and “q” are set as delay times, respectively. As a result, the relay node D transfers the signal received from the source node prior to the relay node C.

Here, the signal arrives at the destination node B by the signal transfer operation by the relay node D. Accordingly, the signal transmitted from the transmission source node A is delivered to the destination node B, and the transmission of the signal is completed. However, in the network within the mesh, the exchange of signals associated with the transfer processing continues.

More specifically, since the received signal strength is “c to d”, the relay node E which has received the signal by the signal transfer operation by the relay node D indexes the delay time “s” based on the table and transmits the received signal to the destination node B after the delay time “s”.

On the other hand, the signals transmitted from the transmission source node A are received by the relay node D and the relay node E. Thereafter, the transmission timing is determined by referring to the table in accordance with the received signal strength at the time of reception, and then the transfer operation is performed.

In the techniques disclosed in Patent Document 1, transmission timings are controlled by using random values or values calculated based on the serial numbers of each of the wireless terminals so that transmission timings in a plurality of wireless terminals do not coincide with each other.

Contrary to Patent Document 1, the first embodiment sets a delay time according to the received signal strength as described above, each node having different received signal strengths are provided differences in the delay times. That is, by determining the delay time according to the distance from the preceding transmission node, i.e., relay node or source node, and then performing the relay operation, it is possible to avoid the collision of the signal without wasting the waiting time.

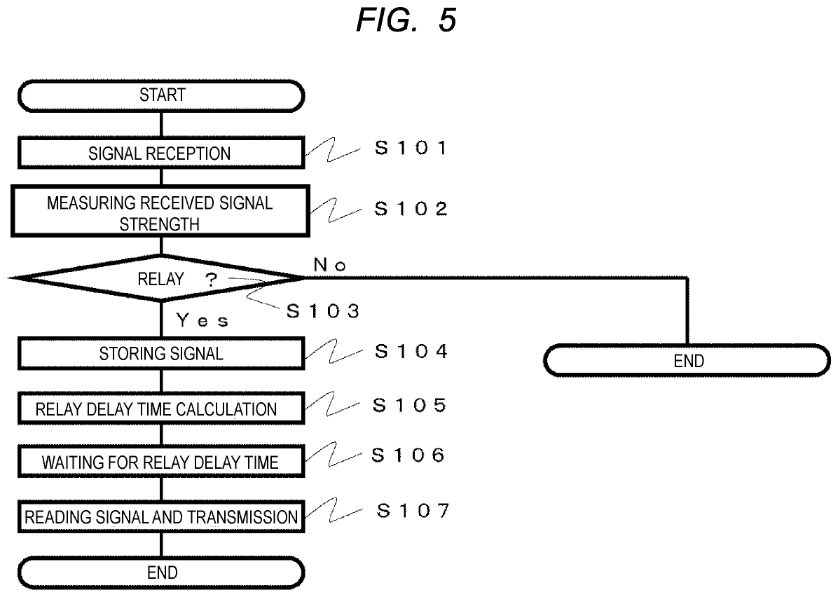

Next, the operation of the relay node, i.e., the signal relay method, will be described with reference to the flowchart shown in FIG. 5. First, the antenna unit 2 receives signals from other nodes, and the transmission and reception unit 3 receives the signals in step S101 (also referred to as a reception step). Next, the transmission and reception unit 3 notifies the received signal evaluation unit 4 that a signal has been received. Then, the received signal evaluation unit 4 measures the received signal strength by this notification as a trigger, and notifies the transmission and reception unit 3 of the received signal strength in step S102 (also referred to as a measuring step).

Next, the signal relay control unit 5 refers to the address portion of the signal received by the transmission and reception unit 3, and checks whether the destination address is that of the relay node itself or not in step S103. When it is determined that the destination address is not its own address (YES in step S103), the signal received by the transmission and reception unit 3 is stored in a predetermined buffer in step S104. In addition, when it is determined that the destination address is its own address (NO in step S103), the relay processing ends.

Next, the signal relay delay time calculation unit 6 determines the delay time based on the received signal strength notified from the received signal evaluation unit 4 and the table shown in FIG. 2 in step S105 (also referred to as a determination step). Next, the signal relay control unit 5 receives the signal from the transmission and reception unit 3, and then transmits the signal stored in the buffer in step S104 after the delay time determined in step S105 has elapsed in step S106 and step S107.

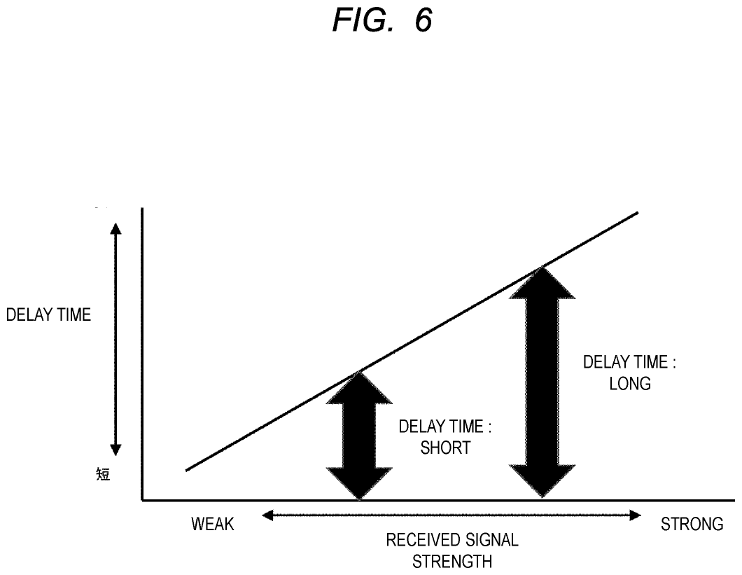

As described above, the relationship between the distance from the preceding node and the received signal strength is as shown in FIG. 3. That is, a node having a weak received signal strength is far from a node at the preceding stage. Accordingly, as shown in FIG. 6, by making the relay operation delay time shorter as the received signal strength is weaker, more communication between more distant nodes is selected, and it is possible to deliver a signal with a smaller number of relay nodes between the source node and the reception node.

In other words, the number of relay nodes passing from the source node to the destination node can be reduced, that is, the number of hops can be reduced. The fact that the received signal strength is low means that the distance from the node that transmitted the signal is long, and then selecting a node at such a long distance and a path to the destination node can suppress the number of nodes passing through.

The first embodiment has been described above. In the relay node according to the first embodiment, the relay node determines the delay time in accordance with the received signal strength when the relay node receives the signal. More specifically, the smaller the received signal, that is, the longer the distance from the preceding node, the faster the relay processing is performed by each relay node. As a result, it is possible to reduce the waiting time for each relay node to perform the relay operation, and thus it is possible to reduce the delay time required for the signal communication from the source node to the destination node.

### Second Embodiment

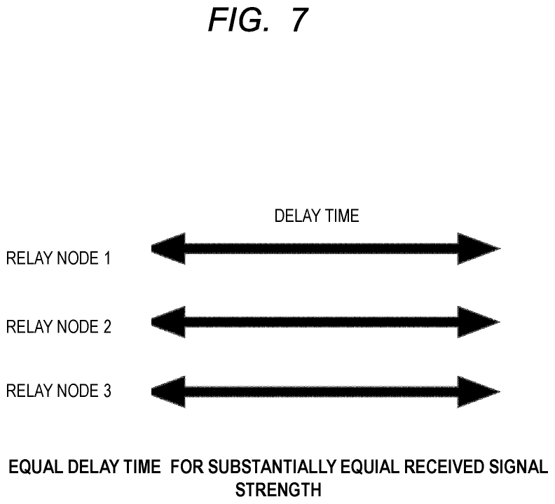

Next, a description will be given of second embodiment. As shown in FIG. 7, when the received signal strengths of the relay nodes 1 to 4 receiving signals from the preceding nodes (signal source nodes or relay nodes) are substantially equal to each other when the signals are received from the preceding nodes, the delay time determined by using the common table becomes substantially equal to each other, and there is a concern that a collision may occur at the time of signal transmission in each relay node. This is because the delay times become equal when there is no large difference in the distance from the preceding node to each of the relay nodes 1 to 4.

In present embodiment, each relay node is configured to include a random number generation unit, and even when the distances from the signal source node are substantially equal to each other, signal collisions are avoided by setting differences in the relay delay times.

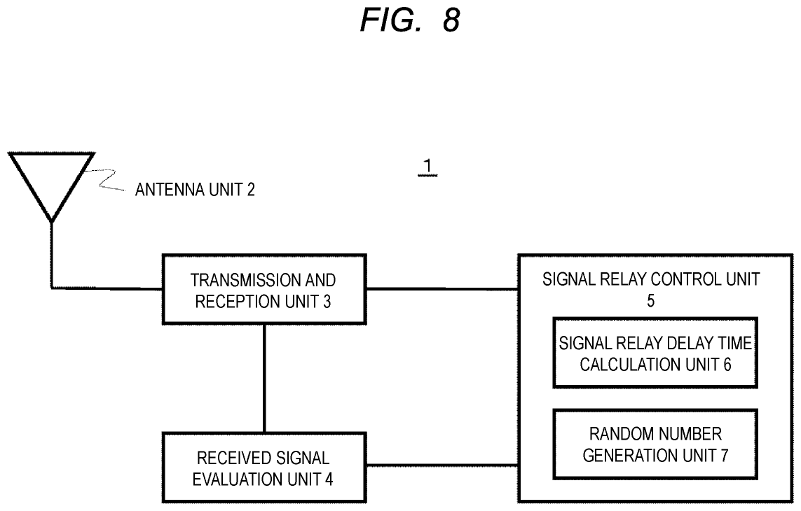

Referring to FIG. 8, the configuration of the relay nodes in the second embodiment will be described. As shown in FIG. 8, relay node 1 according to the second embodiment includes an antenna unit 2, a transmission and reception unit 3, a signal relay control unit 5, and a received signal evaluation unit 4. The signal relay controller 5 includes a signal relay delay time calculation unit 6 and a random number generation unit 7. The difference from the first embodiment is that the relay node 1 includes a random number generation unit 7. The random number generation unit 7 has a function of randomly selecting and outputting a number from a number within a range specified in advance. More specifically, in the second embodiment, the signal relay delay time calculation unit 6 adds an offset delay value corresponding to the random number value outputted from the random number generation unit 7 to the delay time.

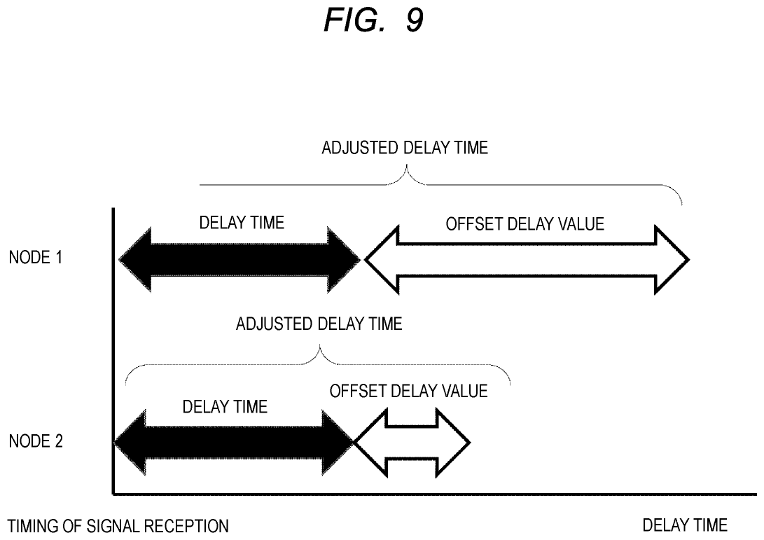

A more specific description will be given with reference to FIG. 9. When the received signal strengths for the received signals are substantially equal as in the case shown in FIG. 7, the same delay times are set for both the node 1 and the node 2 that received the same signal from the preceding node by the control using the shared table in the first embodiment procedure as shown by a black arrow in FIG. 7.

Therefore, in the second embodiment, as shown by a white arrow, by adding an offset delay based on a random number to the delay time, differences are made in the offset delay times in the node 1 and the node 2, and then collisions of signals are avoided.

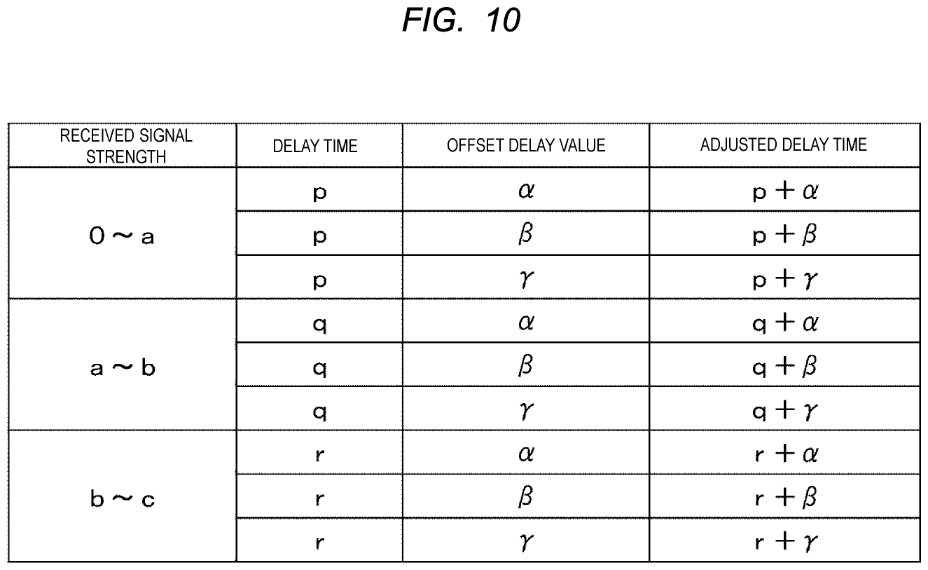

Next, with reference to FIG. 10, a mechanism for determining delay times from received signal strengths in the second embodiment will be described in more detail. As shown in FIG. 10, each relay node includes a common table defining a delay time corresponding to the received signal strength. For example, when the table shown in FIG. 3 in the first embodiment is used, if the received signal strengths of the relay node B and the relay node C, which received the signal transmitted from the source node A, both fall under “a to b”, the delay times are both “q”.

As described above, if the relay times coincide with each other, there is a concern that a signal collision occurs. In second embodiment, for example, the delay time “q” is added to the random number a as the offset delay value for the relay node B to obtain the adjusted delay time, and the delay time q is added to the random number y as the offset delay value for the relay node C to obtain the adjusted delay time, thereby the relay timing is controlled not to coincide.

In this manner, when a signal is received from a preceding node, if the distance from the preceding node is substantially equal and then the received signal strength is substantially equal when a signal is received from the preceding node, a difference in transmission timing can be provided by adding a delay time based on a random number value, thereby signal collision can be avoided.

The second embodiment has been described above. In the relay node according to the second embodiment, the relay time is determined so that the collision does not occur between the relay nodes having values close to the received signal strength at the time of receiving the signal. More specifically, in addition to the control according to the received signal strength disclosed in the first embodiment, by adding the time based on the random number as the offset delay, it is possible to control the transmission timing of each of a plurality of relay nodes at substantially equal distances from the transmission source node and the preceding relay node so that the transmission timings of the relay nodes do not coincide with each other. As a result, it is possible to suppress the occurrence of signal collision.

### Third Embodiment

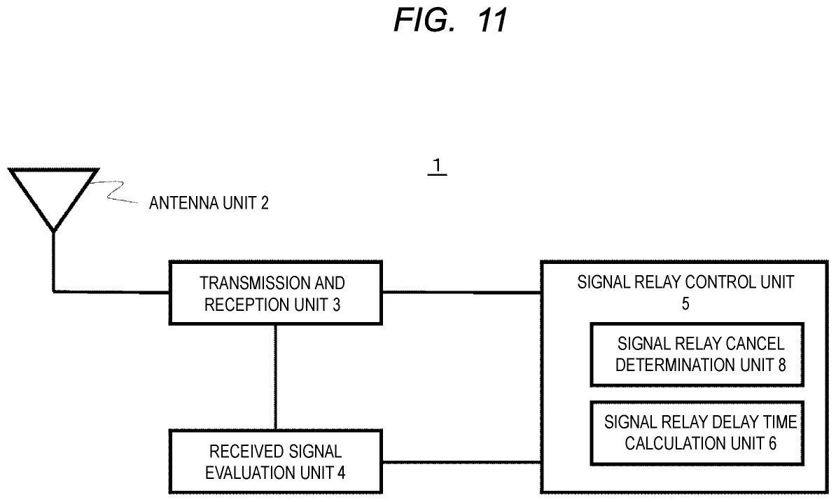

It shows a block configuration diagram of a relay node according to third embodiment in FIG. 11. As shown in FIG. 11, the relay node 1 according to the third embodiment includes an antenna unit 2, a transmission and reception unit 3, a received signal evaluation unit 4, and a signal relay control unit 5. The signal relay control unit 5 includes a signal relay delay time calculation unit 6 and a signal relay cancel determination unit 8. The difference between the configuration of the relay node 1 of the third embodiment and the configuration of the relay node 1 of the first embodiment shown in FIG. 1 is that a signal relay cancel determination unit 8 is provided which controls not to relay a corresponding signal, i.e., a signal received by the destination node, when the destination node transmits an acknowledge, i.e., “Ack” signal for notifying the source node that the signal has been received.

When each relay node receives an “Ack” signal for the signal from another node before receiving the signal from the transmission source node, the signal relay cancel determination unit 8 performs control so as not to perform the relay operation of the signal corresponding to the “Ack” signal.

With the control in the third embodiment, it is possible to avoid the relay processing again for the signals that have been subjected to the relay processing. As a result, the number of signals processed in the mesh network can be reduced, and it is possible to prevent the network from falling into a congestion state.

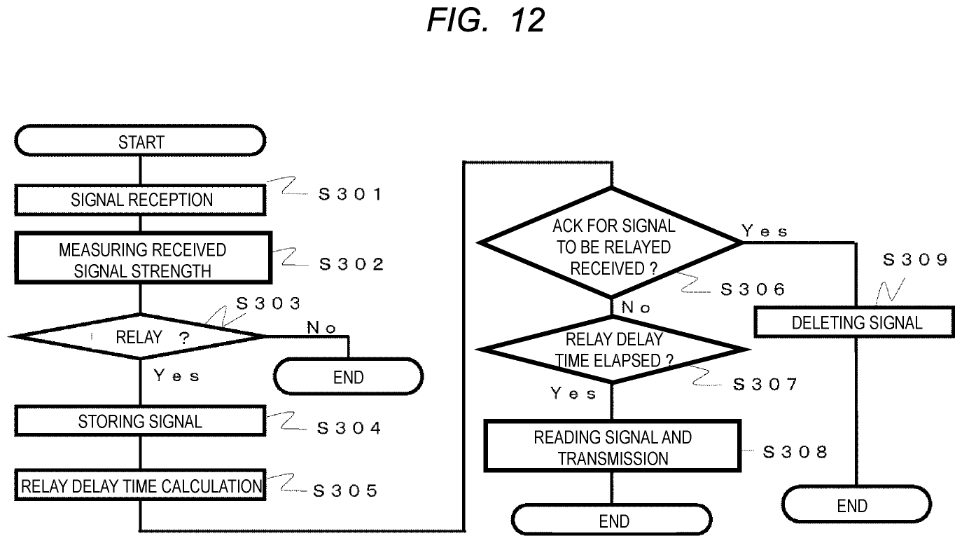

Next, the operation in the relay node will be described with reference to the flowchart shown in FIG. 12. First, signals are received by the antenna unit 2 in step S301. Next, in step S302, the transmission and reception unit 3 notifies the received signal evaluation unit 4 of the received signal strength at the time of receiving the signal.

Next, the signal relay control unit 5 refers to the address portion of the signal received by the transmission and reception unit 3, and confirms that the destination address is not that of the relay node itself in step S303. When it is determined that the signal is to be relayed, i.e., the destination address is not the address of the own in step S303, the transmission and reception unit 3 stores the received signal in a predetermined buffer in step S304.

Next, the signal relay delay time calculation unit 6 determines the delay time based on the received signal strength notified from the received signal evaluation unit 4 and the table shown in FIG. 2 in step S305. Next, the signal relay cancel determination unit 8 determines whether or not the “Ack” signal for the signal to be relayed has been received in step S306.

If the “Ack” signal has been received, i.e., YES in step S306, the signal to be relayed under waiting is deleted in step S309. When the “Ack” signal for the signal to be relayed is not received, i.e., No in Step S306, after the relay delay time has elapsed in Step S307, a processing of relaying the signal is performed in Step S308.

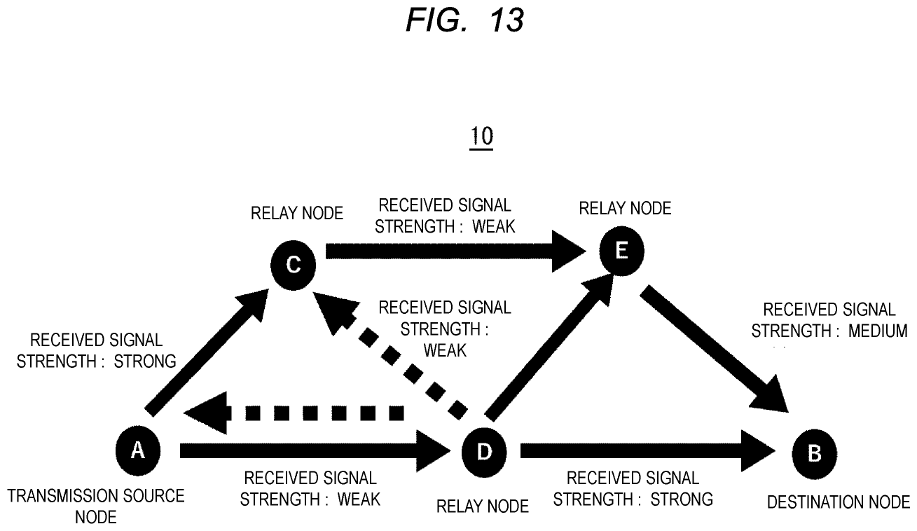

FIG. 13 is a diagram showing an exemplary configuration of a communication system of a mesh network according to the third embodiment. In the communication system 10 of FIG. 13, the node A is the source node and the node B is the destination node. Nodes C to E indicate relay nodes that transmit signals from source node A to destination node B and then transfer the signals on their paths.

The third embodiment has been described above. In the relay node according to the third embodiment, when each relay node receives an “Ack” signal from another node, the number of signals in the mesh network can be reduced and the generation of collisions can be suppressed by controlling the signal relay cancel determination unit not to relay a signal corresponding to the “Ack” signal.

Although the invention made by the inventor has been specifically described based on the embodiment, the present invention is not limited to the embodiment already described, and it is needless to say that various modifications can be made without departing from the gist thereof.

What is claimed is:

1. A relay node comprising:
a transmission and reception unit that transmit and receive a signal;
a received signal evaluation unit that measures a received signal strength when the signal is received; and
a signal relay control unit that determines a signal relay delay time until the signal is transferred in accordance with the reception signal strength.

2. The relay node according to claim 1, wherein the signal relay control unit makes the signal relay delay time shorter as the received signal strength is weaker.

3. The relay node according to claim 1, wherein the received signal evaluation unit measures the received signal strength when the transmission and reception unit notifies that the signal has been received.

4. The relay node according to claim 1, further comprising a random number generation unit,
wherein the signal relay delay time is added by a delay time based on a random number output from the random number generation unit.

5. The relay node according to claim 1, wherein the signal is discarded if a same signal as the signal has been received from another node before the relay node receives the signal.

6. A signal relay method in a relay node, comprising:
receiving a signal;
measuring a received signal strength when the signal is received;
determining a signal relay delay time in response to the received signal strength; and
transmitting the signal to another node after the signal relay delay time has elapsed after the signal is received.

7. The signal relay method according to claim 6, wherein the determining includes making the signal relay delay time shorter as the received signal strength is weaker.

8. The signal relay method according to claim 6, wherein the received signal strength is obtained by measuring the signal when the relay node receives the signal.

9. The signal relay method according to claim 6, further adding a delay time based on a random number to the signal relay delay time.

10. The signal relay method according to claim 6, wherein the signal is discarded if a same signal as the signal is received from another node before receiving the signal. A communication system comprising:
a transmission node that transmits a signal;
a plurality of relay nodes that relay the signal to another node; and
a receiving node as a destination of the signal,
wherein the plurality of relay nodes determines a signal relay delay time according to a received signal strength when the signal is received, and transmits the signal to another node after the signal relay delay time has elapsed from the signal is received.

12. The communication system according to claim 11, wherein the plurality of relay nodes makes the signal relay delay time shorter as the received signal strength is weaker.

13. The communication system according to claim 11, wherein the received signal strength is obtained by measuring the signal when the plurality of relay nodes receives the signal.

14. The communication system according to claim 11, further comprising a random number generator,
wherein the signal relay delay time is added by a delay time based on a random number output from the random number generation unit

15. The communication system of claim 11, wherein the signal is discarded if a same signal as the signal has been received from another node before the plurality of relay nodes receives the signal.
